(19) United States
(12) Patent Application Publication
(10) Pub. No.: US 2006/0174170 A1
(43) Pub. Date: Aug. 3, 2006

(54) Integrated reporting of data

(76) Inventors: Peter Garland, Natick, MA (US); Timothy A. Mulherin, Hudson, MA (US)

Correspondence Address: FISH & RICHARDSON PC, P.O. BOX 1022, MINNEAPOLIS, MN, 55440-1022, US

(21) Appl. No.: 11/045,187

(22) Filed: Jan. 28, 2005

(51) Int. Cl. G06F 11/00

(52) U.S. Cl. 714/57

(57) ABSTRACT

Application-specific terminology for a test data element produced by a test management tool is converted into a standard terminology. A mapping strategy is used to map the application-specific terminology to the standard terminology. A report showing the test data element expressed in the standard terminology is delivered.

### TECHNICAL FIELD

This disclosure relates to integrating data, such as testing data, collected from one or more sources.

### BACKGROUND

A test management tool is a software application that reports the results of tests performed on a software application. Test management tools, often accessible by a large number of local and/or remote users over a distributed network, are used to maintain and process test data that an executive may use to monitor the status of projects across a company or across several companies. Though multiple test tools may perform similar testing processes, the tools often display the test data differently from one another using dissimilar terminology to describe the data.

### SUMMARY

The invention provides methods and systems, including computer readable mediums, for normalizing test data produced by multiple test management tools.

In an aspect, the invention features a method for converting application-specific terminology for a test data element produced by a test management tool into a standard terminology. A mapping strategy is used to map the application-specific terminology to the standard terminology. A report showing the test data element expressed in the standard terminology is delivered.

Embodiments may include one or more of the following. The test data element may be automatically pulled from the test management tool or pushed from the test management tool. The test data element may include a label containing a description of the test data element and at least one value associated with the label. The application-specific terminology may include a description of the test data element, a numerical value, and an expression of degree on a scale. The mapping strategy may define a rule for translating the application-specific terminology to the standard terminology. The mapping strategy may be used to assign the test data element to a test artifact that belongs to one of a plurality of predetermined categories of test artifacts. The predetermined categories may have a hierarchy and include requirement artifacts, test case artifacts, execution artifacts, and defect artifacts

In embodiments, the method may include converting application-specific terminology for a second test data element produced by a second test management tool into a standard terminology using a second mapping strategy that maps the application-specific terminology of the second test management tool to the standard terminology. Using the mapping strategy, a second test data element may be assigned to a second test artifact belonging to one of multiple predetermined categories of test artifacts. A traceability path may be defined between the first test artifact and the second test artifact. The first and second test data elements expressed in the standard terminology and in a single view may be shown in the report. The report may be delivered as a hardcopy report. The report may be displayed in a graphical user interface.

In another aspect, the invention features a method for defining a mapping strategy for a test data element produced by a test management tool. The mapping strategy is stored in a computer and used to translate application-specific terminology for the test data element collected from the test management tool to a standard terminology. A report shows the test data element, collected from the test management tool, expressed in the standard terminology.

Embodiments may include one or more of the following. By computer, the test data element collected from the test management tool may be assigned to one of a plurality of predetermined hierarchical groupings using the mapping strategy. The hierarchical groupings may include a test artifact, a testing effort, a project, an initiative, and a domain. The test artifact may belong to one of multiple predetermined categories of test artifacts that may have a hierarchy. The initiative may include multiple projects organized as a project hierarchy.

In another aspect, the invention features a computer readable medium having instructions stored thereon, that, when executed by a processor, cause the processor to store a mapping strategy in memory. The mapping strategy maps application-specific terminologies of first and second test data elements to a standard terminology. First and second test data elements from a test management tool are received. The first and second test data elements are assigned to first and second test artifacts using the mapping strategy. The application-specific terminologies of the first and second test data elements are translated to the standard terminology using the mapping strategy. A report showing the first and the second test data elements expressed in the standard terminology and displayed in a single view is delivered.

Embodiments may include one or more of the following. The first and second test artifacts may occupy levels in a hierarchy. The report may contain the test data elements displayed in one of multiple predefined templates that include a graph, a grid, and a hierarchical grid. The test artifacts may be grouped into projects and the projects may be grouped as a hierarchy. The report may be generated from any level in the hierarchy.

In embodiments, a third test data element may be reported. A second mapping strategy may be stored in memory for mapping an application-specific terminology of the third test data element to a standard terminology.

The third test data element may be assigned to a third test artifact using the second mapping strategy. Application-specific terminology of the third test data element may be translated to the standard terminology using the second mapping strategy. A report showing first, second, and third test data elements expressed in the standard terminology and displayed in a single view may be delivered.

In another aspect, the invention features a system for normalizing test data produced by multiple test management tools. A first collection of one or more data files containing data elements produced by a plurality of different test management tools are provided. A mapping module is provided to receive the first collection of data files and to convert terminology of the data elements stored in the first collection of data files to a standard terminology.

Embodiments may include one or more of the following. A second collection of one or more data files containing the converted data elements may be provided. A display adapted to present a report of the converted data elements may be provided. The report may be delivered to a user electronically. The report may be delivered to a user via a password-secured web interface. The mapping module may be configured to map the data elements to a plurality of hierarchical groupings. The mapping module may store instructions for converting the data elements into the standard terminology and for mapping the data elements to the plurality of hierarchical groupings. Tools for extracting the first collection of one or more data files from the test management tools may be provided. The tools may automatically extract the first collection of one or more data files.

Embodiments of the invention may have one or more of the following advantages.

Test data from different test management tools may be normalized by converting application-specific terminology of the test data to a standard terminology. Normalizing the test data reduces the guesswork of matching disparate application-specific terminology by enabling a user to compare the data as “apples to apples.”

In embodiments, terminology describing the test data includes labels that describe the kind of data, values associated with the labels, and degrees on scales (e.g, a rating of 7 on a scale from 1 to 10). Related elements of the test data may be organized into hierarchical groupings to help a user more easily distinguish relationships between various elements of the test data. For example, test data elements related to the specifications of a testing effort may be grouped as requirement artifacts. Test data elements describing various input conditions applied to the testing effort may be grouped as test-case artifacts. Test data elements describing the results from an applied test case or combination of test cases may be grouped as execution artifacts. Test data elements characterizing the violation of a specification for a given test case may be grouped as defect artifacts. Requirement artifacts, test-case artifacts, execution artifacts, and defect artifacts may be linked together and categorized hierarchically.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 shows a block diagram of a test-data reporting environment.

FIG. 2 illustrates hierarchical groupings of test data.

FIG. 3 illustrates a hierarchical relationship between test artifacts.

FIG. 4 is a flow diagram of a test data reporting process.

FIG. 5 is a flow diagram for creating a template to map an application-specific terminology to a standard terminology.

FIG. 6 shows a web interface by which a user accesses reports.

FIG. 7 shows an example of a report.

### DETAILED DESCRIPTION

Different terminologies used by different software applications to report data can be resolved by converting application-specific terminologies to a standard terminology through a process called “data normalization.” For example, a test management tool might use the term “execution time” to describe the time required by a software application under test to perform a computation, while a different software test management tool might describe the same data using the term “run time.” When comparing the data reported by each of the testing tools, a user, such as an executive who oversees several testing efforts, may have difficulty comparing the “execution time” reported by the first tool with the “run time” reported by the second tool if she does not know that “execution time” and “run time” have the same meaning. Furthermore, the second tool might describe data using the term “execution time” but define the term differently than the first tool. As a result, a user may draw an incorrect comparison if she assumes that “execution time” for both test tools refers to the same data type.

Furthermore, the first tool might report the run-time error on a severity scale of one to ten, while the second tool reports the run-time error on a severity scale having three levels, “low”, “medium”, and “high.” If the user is uncertain as to how the two severity scales map to each other, she will have difficulty reconciling the severity readings from the different tools. Translating application-specific terminologies of data from the different tools to a standard terminology through a data normalization process reduces the guesswork of matching disparate terminology.

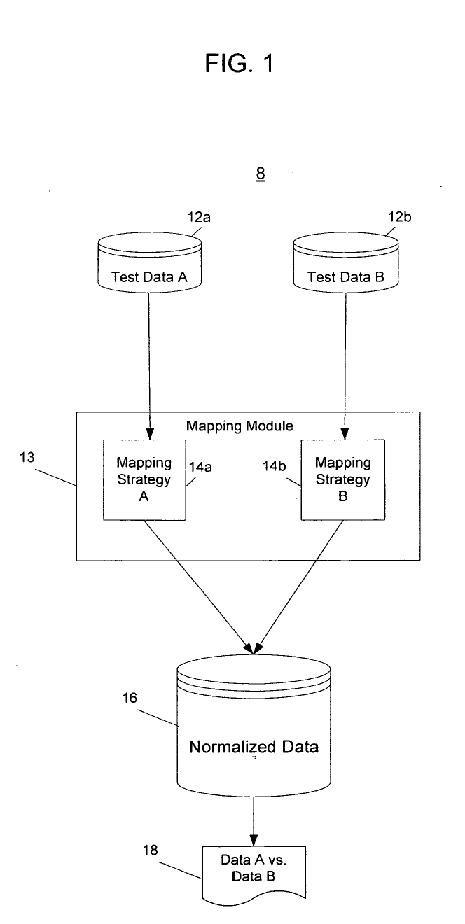

Referring to FIG. 1, a test data reporting environment 8 includes test data 12a-12b obtained from separate testing applications that each have application-specific terminology. The test data reporting environment also includes mapping strategies 14a-14b defined for each of the test testing applications, a mapping module 13 that uses mapping strategies 14a-14b to convert application-specific terminologies of the data 12a-12b to a standard terminology, normalized test data 16 derived from test data 12a-12b, and an integrated reporting tool 18 that displays the normalized test data 16 in a single view.

Test data 12a-12b is a collection of data elements produced by a data testing source. A data element includes a label describing the data-type and at least one value associated with the label. For example, a data element expressing a run time of 10 milliseconds would have a label that contains the string, “run-time,” and an associated numerical value, e.g., “10 ms.”

Test data 12a-12b may be produced by any known data testing source. For example, test data 12a-12b may be a repository of data produced by testing tools such as Mercury Quality Center offered by Mercury Interactive Corporation (www.mercury.com). and Rational ClearQuest offered by IBM Corporation (www.ibm.com). The test data 12a-12b may also be produced by local desk top applications such as Microsoft Excel or Microsoft Word, both available from Microsoft Corporation (www.microsoft.com). The test data may be in any known file format such as a Microsoft Word document file, Microsoft Excel spreadsheet file, delimited text file, or a custom-designed file format.

The data elements of test data 12a-12b contain application-specific terminology which may be terminology used to describe labels (e.g., “execution time”, “run time”) or may be terminology used to express values, such as a numerical value (e.g., “10 ms”, “0.10 seconds”) or degrees on scales (e.g., a rating of 7 on a scale from 1 to 10, or a rating of “high” on a scale of “high,” “medium,” and “low”). In FIG. 1, for example, test data 12a could be in the form of a spreadsheet that records data from a quality assurance test application that tests software for memory allocation defects. The spreadsheet may have data elements for each defect that specifies the severity of each defect on a scale of “high”, “medium”, or “low”. Test data 12b could be collected in a fixed ClearQuest™ repository that reports memory allocation defects of web applications and specifies the severity of each defect on a scale from 1 to 5, with five being the most severe. A user, such as an executive overseeing both test efforts, might wish to compare the severity of the defects reported by each testing tool.

The mapping module 13 converts the test data produced by each software testing tool to normalized data expressed in a common terminology, and the integrated reporting tool 18 displays the normalized test data in a graphical user interface. Thus, for example, rather than showing the severity data for a particular defect as “high” for data 12a and as a “2” for data 12b, the report may convert the data to be expressed on a common scale of “critical”, “severe”, “moderate” and “low”. By displaying the data 12a and 12b normalized to the same terminology, in this case a four-level severity scale, a user reviewing the report compares the data 12a-12b as “apples to apples”.

The normalized data 16 could be organized in a database or in a collection of databases and stored in any known storage medium including a hard drive and a storage area network.

A user, such as a software administrator, can access the mapping strategies 14a-14b contained in mapping module 13 via a network, for example, a local area network (LAN) or a larger group of interconnected systems such as the Internet. In one setup, normalized test data 16 is transmitted and received over a high-speed bus, such as a PCI, VMEbus, USB, ISA, or PXI bus. In another arrangement, normalized test data 16 is transmitted over a network which could include a wireless network.

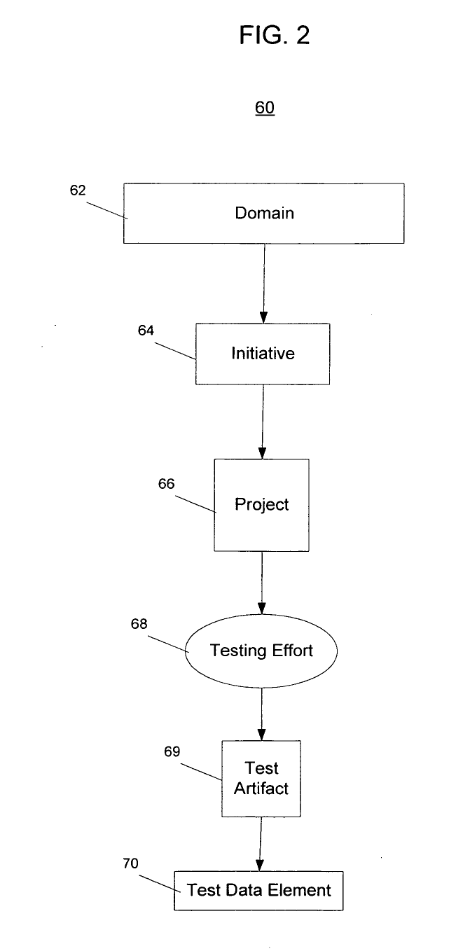

Referring to FIG. 2, the normalized test data 16 is organized into hierarchical groupings 60 that include a domain 62, an initiative 64, a project 66, a testing effort 68, and a test data element 70. The user may select data from any of the hierarchical groupings 60 to be displayed in a report 18.

The domain 62, occupying the top level of the hierarchy, could include a company or group of companies. The domain 62 could also be a product or a group of products. The domain 62 is composed of one or more initiatives 64. An initiative 64 could be a quality analysis group or multiple quality analysis groups. Multiple initiatives could be assigned to multiple divisions within a domain 62. An initiative 64 may oversee multiple projects 66.

A project 66 could be a product, such as a software application or a task to be completed, such as an audit or a marketing plan. The projects 66 overseen by an initiative 64 could be organized in a project hierarchy. For example, the user might organize a list of projects 66 pertaining to software applications according to a dependency hierarchy in which the applications that are called by other applications receive priority. A project 66 holds a set of one or more test efforts 68.

A test effort 68 describes the test being performed, the test scenarios, and the results. For example, a test effort might test how quickly a module of a software application executes a function. A test effort 68 is composed of one or more test artifacts 69. Test data elements 70 are grouped into one of four categories of test artifacts 69. These categories include requirement, test case, execution, and defect artifacts. Test artifacts 69 delineate the relationships between various test data elements 70 and are described below in further detail.

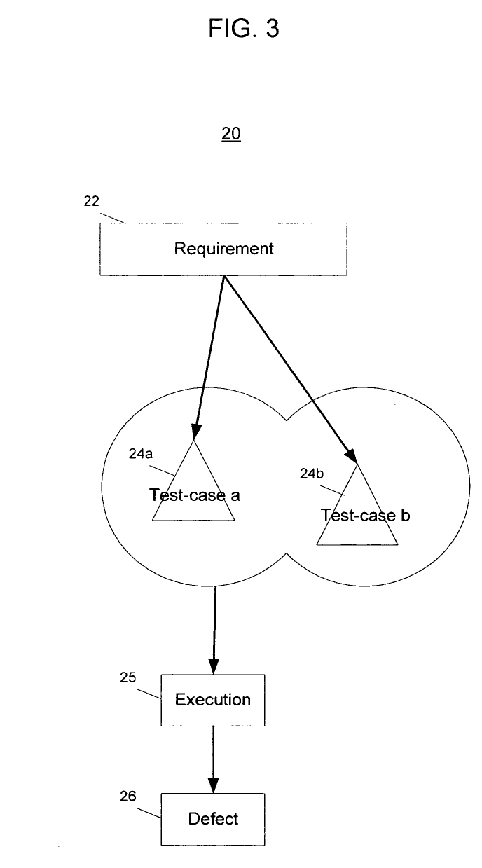

A test artifact 69 is a grouping of related test data elements 70. Test artifacts 69 are divided into four categories of artifacts which include: requirement, test case, execution, and defect artifacts. Referring to FIG. 3, a hierarchical relationship 20 between the four categories of test artifacts are shown. The requirement artifact 22, occupies the top level of the hierarchy 20, while the defect artifact 26 resides at the lowest level. The test-case artifacts 24a-24b are linked to the requirement artifact 22 and to the execution artifact 25. The execution artifact is linked to the test-case artifacts 24a-24b and to the defect artifact 26a. The link between test artifacts is described by a name or an internal ID. In this manner, every test artifact belonging to a testing effort 68 can be traced to all other test artifacts in that testing effort 68.

Requirement artifacts are specifications that are tested subject to a set of rules, i.e., requirement artifacts describe what is being tested. For example, the requirement artifact 22 may specify that the execution time for an application under test must not exceed a predetermined value. If the application performs a series of individual operations that each requires a predetermined time period to execute, a rule might define the execution time as the sum of time for a sequence of performed operations. Other rules might state the times required to complete the individual operations. The data elements of a requirement artifact 22, for example, might include a description of the requirement being tested, an importance indicator for meeting the requirement, and a person responsible for ensuring that the requirement is met. Requirement artifacts are typically supplied in a System Requirements Analysis (SRA) document or as a System Delivery Specification (SDS).

Test-case artifacts determine if a requirement is met by applying various input conditions to the rules. For example, test case artifacts 24a-24b might be different sequences of operations that the application could perform. For instance, test-case artifact 24a could be the execution of a Boolean operation and an addition operation, while a test-case artifact 24b might be the execution of a division operation followed by an addition operation. A single requirement may be linked to one or more test case artifacts. Likewise, a single test-case artifact may be linked to multiple requirement artifacts. Test-case artifacts may also be linked to multiple requirements covering different categories of functionality such as navigation to a screen, the interactions of the screen while performing some transaction, the results of that transaction system, and the various outputs that transaction may produce. Test-case artifacts are often grouped into clusters that may be further grouped into collections of clusters.

Execution artifacts 25 contain the test results derived from an applied test case or a combination of applied test cases. Though test cases can be executed multiple times in the life of a project, the result of each execution is stored in its own entry. Therefore, a test case artifact could be linked to multiple execution artifacts. An execution artifact might contain test data elements that describe the time when a test was executed, and a status indicator that describes whether or not a requirement has failed for a given test case or group of test cases.

Defect artifacts 26 store data when requirements or rules are violated for given sets of test cases. A defect artifact 26 might include a data element that describes the severity of a defect, a data element that contains the test case or group of test cases in which the defect resulted, and a data element that provides a description of the defect. The defect artifact 26 might also contain a data element that inherits an importance indicator value assigned to requirement artifact 22. Defect artifacts can be traced back to the test cases from which they originated and to the requirement that was tested.

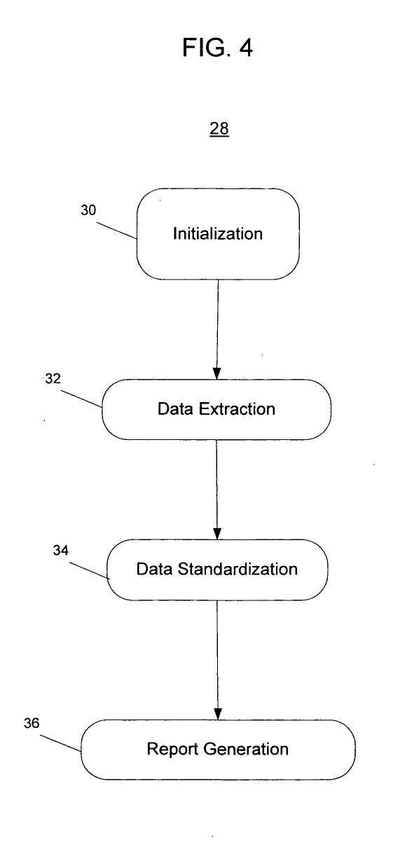

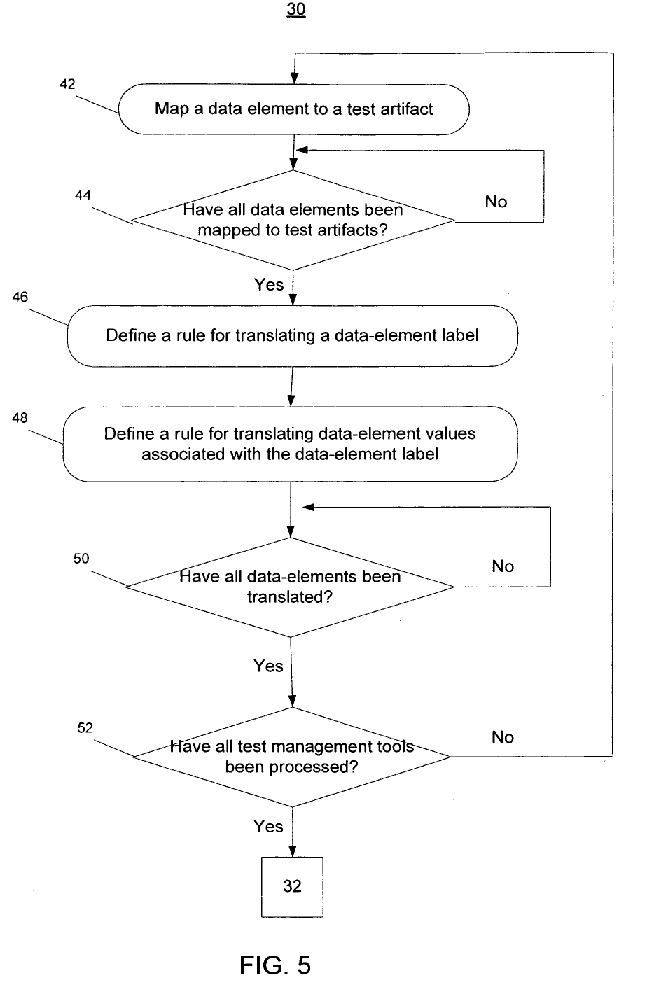

Referring to FIG. 4, a process 28 for normalizing test-data 12a-12b and reporting the normalized data 16 in an integrated report 18 is described. The process 28 includes an initialization procedure 30 in which an administrator maps test data elements to test artifacts and defines mapping strategies for converting application-specific terminology to a standard terminology. For example, an administrator could define a mapping strategy 14a that groups all data elements containing the label “memory over-run” into a defect article. Furthermore, the administrator could define a mapping strategy 14a to equate the term, “memory over-run”, unique to test data 12a, to a standard term, “memory allocation error.” The administrator may configure mapping strategy 14a to map test data 12a into hierarchical groupings 60 that can include testing efforts 68, projects 66, initiatives 64, and domains 62. Mapping strategy 14a may also organize projects 66 into a project hierarchy. During the initialization procedure 30, the administrator creates another mapping strategy 14b for test data 12b. The administrator could perform the initialization procedure 30 from a remote terminal via a web interface or from a terminal connected to the system 8 through a private intranet. Further descriptions and examples of data initialization 30 are later discussed in conjunction with FIG. 5. After the administrator completes the initialization procedure 30, the remaining data extraction, normalization, and reporting procedures 32, 34, and 36 are preferably executed automatically. The administrator need not convert every data element to a standard terminology. Indeed, often data elements will not change during the normalization process. For example, if a data element provides a description of a test that was conducted, that description (i.e., the “value” of the data element) may not change during the normalization process.

Data extraction 32 is a process by which test data is removed from the repositories and sent to the mapping module. Data can be extracted from repositories using either a “pull” or “push” data transfer technique. For example, a repository of test data produced from specialized software testing tools such as Rational ClearQuest is automatically pulled into the mapping module on a scheduled basis. A data file containing test data produced by a desktop application such as a spreadsheet is uploaded or “pushed” to the mapping module. Uploading of data may commence automatically at defined time intervals or be performed manually by a user through a web interface. For example, a user could upload the data using a simple electronic cut and paste into a web page. In another example, multiple users could upload data. In this scenario security measures would be taken to ensure that a user uploads data only to the projects assigned to that user. Such a security measure could be accomplished by assigning the user a password that grants access only to projects for which the user is verified.

Tools for accessing the repositories include Open DataBase Connectivity (ODBC), a standard application program interface for accessing a database; Structured Query Language (SQL), a standardized query language for requesting information from a database; and ActiveX Data Objects (ADO), a solution for accessing different types of data, including web pages, spreadsheets, and delimited text files. An event log records event messages and information generated by the extraction process.

The data standardization process 34 converts the extracted data from its application-specific format to a standard format. The process 34 uses the mapping strategies developed during the initialization process 30. For example, mapping strategy 14a might contain an instruction to change every instance of the term “memory over-run” contained in test data to a standard term “memory allocation error.” The standardization process 34 automatically reads the instruction from mapping strategy 14a and overwrites each “memory over-run” term with a standard term “memory allocation error.” The process is repeated for other terminology, which includes descriptive language, numerical values, and values calibrated to a scale.

The data standardization process 34 also groups data into requirement, test case, execution, and defect artifacts. The data may be grouped into further hierarchical groupings 60 that include testing efforts, projects, initiatives, and domains. The groupings are based on instructions defined in the mapping strategy for each test management tool. For instance, mapping strategy 14a might specify grouping the portions of data 12a containing the field “memory over-run” into a memory defect artifact. The grouping of data into artifacts, testing efforts, projects, initiatives, and domains could be performed before or after the application-specific terminology of the data is translated into a standard terminology. A report generation process 36 provides a user with a report showing the various test data in a single view and described with a common terminology. Through a web interface or the like, the user specifies the test artifacts she would like to view and how she would like them to be organized in the report. The user may decide to organize groups of related test artifacts into multiple projects. The user may further organize related projects as a project hierarchy. The user navigates through the hierarchy and generates reports from any selected level in the hierarchy. The report generation process 36 provides integrated reporting across multiple organizations, channels, and tool sets.

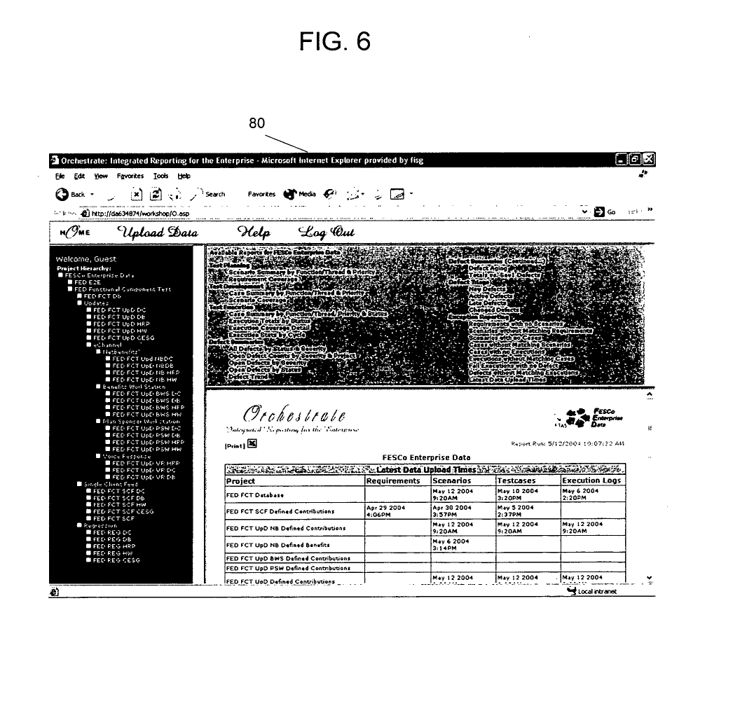

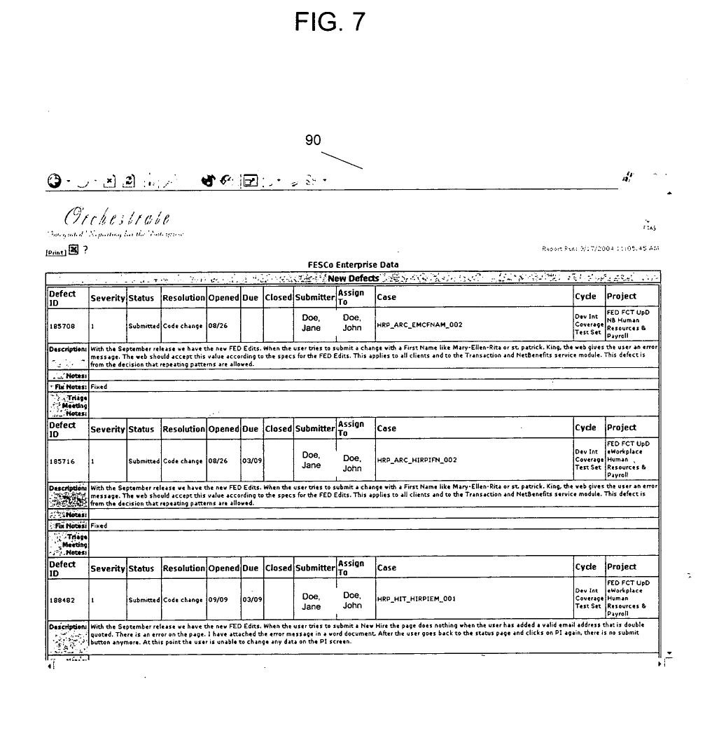

Reports are delivered to the user via a web interface or imported through a desktop application, such as Excel™. Depending on the application, a report is automatically or manually imported. The reporting process 36 contains built-in templates for displaying data. These templates include a spreadsheet, a graph, a grid, and a hierarchical grid. The user displays the data in a template by choosing a template and selecting the data that he wants to display. Further descriptions and examples of reports are later discussed with reference to FIG. 6 and FIG. 7.

Referring to FIG. 5, the initialization process 30 is shown in further detail. The administrator maps a data element to a test artifact 42. For example, the administrator might map data elements that refer to “memory over-run” to a defect artifact. In this example, the administrator might group the data reporting the total memory available into a requirement artifact, the data describing the functions of the process into test-case artifacts, the data listing combinations of functions into execution artifacts, and the data indicating a severity of “memory over-run” errors into defect artifacts. The administrator may also assign importance levels (i.e. low, medium, high, or critical) to requirements when identifying and assigning risk to those area under test. Requirements that are assigned a critical level of importance might be those that have the most impact on her business or those that are most challenging to develop technically. All test case, execution, and defect artifacts inherit the level of importance assigned to their parent requirement. The administrator continues to map data elements to test artifacts 30 until all of the data elements have been mapped 44 for a tool.

The administrator defines a rule for mapping application-specific terminology of a data-element label to a standard terminology 46. As in a previous example, an administrator defines a rule in a mapping strategy that equates an application-specific term, “memory over-run” to a standard term, “memory allocation error,” having generally the same definition as the application-specific term. The administrator defines a rule for mapping application-specific terminology of data-element values, associated with the data-element label, to a standard terminology 48. For example, a data-element value in test data 12a could describe the severity of memory over-run on a scale of one to ten with ten signifying the most urgency, while a data-element value of test data 12b may describe the severity with a ranking of “low”, “medium”, or “high.” In this case, the administrator would configure mapping strategy 14a to calibrate the ten-level severity scale reported in test data 12a to a standard scale, e.g., a four-level scale of “low”, “medium”, “high”, and “critical.” If the administrator thinks that “memory over-run” significantly impacts the project being tested, she might configure mapping strategy 14a to assign the five highest severity levels (five through ten) from the application-specific scale to correspond to “critical” on the standard scale. She may then assign the third and fourth levels from the application-specific scale to “high,” assign the second level to “medium,” and the first level to “low.”

During the mapping process 48, the administrator would also create a mapping strategy 14b for the test data 12b. In this mapping strategy, the administrator might calibrate the severity scale so that the application-specific rankings of “low”, “medium”, and “high” correspond to the standard levels of “low”, “medium”, and “high” where the “critical” level is unused. The administrator could also decide to implement a one-to-one mapping strategy for which certain application-specific terms are not translated to a standard terminology. Such one-to-one mappings would be appropriate for data element values that hold a description string. The administrator continues to map application-specific terminology of data elements to a standard terminology until all of the data elements have been mapped 50 for a tool. The initialization procedure 30 is repeated for each test management tool until all test management tools have been processed 52. The mapping strategies are stored for future use and can modified at any time. Once the initialization procedure 30 is completed, the data is automatically extracted 32, standardized 34 and reported 36 to a user (e.g., the administrator, an executive, etc.).

The user may access reports and generate new reports using a web interface. An example of a web interface 80 for accessing and displaying reports is shown in FIG. 6. The report contains the domain information, such as the company name. In this case, the domain information is FESCo Enterprise. The left hand section of the web interface 80 contains a hierarchy of projects, which can include projects grouped as initiatives. The user can navigate the project hierarchy to access a list of reports or generate a new report for a project or group of projects in a selected level of the hierarchy. A list of available reports for a given level in the project hierarchy is displayed at the top of the web interface. These reports are organized on the basis of their content and grouped together under a common heading. A user may click on a report title, e.g. “Scenarios Summarized by Function/Thread & Priority”, to view the contents of the report. In this example, the contents of the report entitled, “Latest Data Upload Times,” are displayed in a spreadsheet. A report can also be displayed as a graph, grid, or a hierarchical grid.

An example of a report 90 is shown in FIG. 7. The report 90 lists new defects that occurred during a testing of FESCo Enterprise data. In this report, three defect artifacts are shown, each containing data elements with the labels: Defect ID, Severity, Status, Resolution, Opened, Due, Closed, Submitter, Assign To, Case, Cycle, Project, Description, Notes, Fixed Notes, and Triage Meeting Notes. A value field is associated with each label, though some of the values fields are empty, e.g., the value associated with the label, “Closed.” The defect artifacts are displayed in the report 90 with standard formats and standard terminology so that a user may quickly compare the defect data. At the discretion of the administrator, non-standard terminology may not be standardized for certain data elements. For example, the values associated with the “Description” labels might include non-standard terminology.

A number of embodiments of the invention have been described. Nevertheless, it will be understood that various modifications may be made without departing from the spirit and scope of the invention. For example, additional categories of test artifacts could be added to the categories: requirement, test case, execution, and defect; described above. Furthermore, additional attributes such as “scope” and “preferred action” could be assigned to test artifacts. Finally, while the illustrated implementation has been in the context of normalizing test data, the techniques may be applied to normalize other types of disparate data such as accounting data produced by different accounting software applications. Accordingly, other embodiments are within the scope of the following claims.

What is claimed is:

1. A method comprising:
by machine, converting application-specific terminology for a test data element produced by a test management tool into a standard terminology using a mapping strategy that maps the application-specific terminology to standard terminology; and
delivering a report showing the test data element expressed in the standard terminology.

2. The method of claim 1 wherein the test data element comprises:
a label containing a description of the test data element; and
at least one value associated with the label.

3. The method of claim 1 wherein application-specific terminology comprises:
a description of the test data element;
a numerical value; and
an expression of degree on a scale.

4. The method of claim 1 wherein the mapping strategy defines a rule for translating the application-specific terminology to the standard terminology.

5. The method of claim 1 further comprising:
using the mapping strategy to assign the test data element to a test artifact, wherein the test artifact belongs to one of a plurality of predetermined categories of test artifacts.

6. The method of claim 5 wherein the predetermined categories have a hierarchy.

7. The method of claim 6 wherein the predetermined categories include requirement artifacts, test case artifacts, execution artifacts, and defect artifacts.

8. The method of claim 1 further comprising:
by machine, converting application-specific terminology for a second test data element produced by a second test management tool into a standard terminology using a second mapping strategy that maps the application-specific terminology of the second test management tool to the standard terminology; and
delivering a report showing the first and second test data elements expressed in the standard terminology and in a single view.

9. The method of claim 1 wherein delivering a report comprises delivering a hardcopy report.

10. The method of claim 1 wherein delivering a report comprises displaying a report in a graphical user interface.

11. The method of claim 1 further comprising automatically pulling the test data element from the test management tool.

12. The method of claim 1 further comprising pushing the test data element from the test management tool, the pushing being user-initiated.

13. The method of claim 6 further comprising:
using the mapping strategy to assign a second test data element to a second test artifact, wherein the second test artifact belongs to one of a plurality of predetermined categories of test artifacts; and
defining a traceability path between the first test artifact and the second test artifact.

14. A method comprising:
defining a mapping strategy for a test data element produced by a test management tool;
storing the mapping strategy in a computer;
by computer, translating application-specific terminology for the test data element collected from the test management tool to the standard terminology using the mapping strategy; and
delivering a report showing the test data element collected from the test management tool, the test data element expressed in the standard terminology.

15. The method of claim 14 further comprising:
by computer, assigning the test data element collected from the test management tool to one of a plurality of predetermined hierarchical groupings using the mapping strategy.

16. The method of claim 15 wherein the hierarchical groupings include a test artifact, a testing effort, a project, an initiative, and a domain.

17. The method of claim 16 wherein the test artifact belongs to one of a plurality of predetermined categories of test artifacts.

18. The method of claim 17 wherein the categories of test artifacts have a hierarchy.

19. The method of claim 16 wherein the initiative includes a plurality of projects organized as a project hierarchy.

20. A computer readable medium having instructions stored thereon, that, when executed by a processor, cause the processor to:
store a mapping strategy in memory for mapping application-specific terminologies of first and second test data elements to a standard terminology;
receive first and second test data elements from a test management tool;
assign the first test data element to a first test artifact using the mapping strategy;
assign the second test data element to a second test artifact using the mapping strategy;
translate the application-specific terminologies of the first and second test data elements to the standard terminology using the mapping strategy; and
deliver a report showing first and second test data elements expressed in the standard terminology and displayed in a single view.

21. The computer readable medium of claim 20 wherein the first and second test artifacts occupy levels in a hierarchy.

22. The computer readable medium of claim 20 wherein the report contains the test data elements displayed in one of a plurality of predefined templates, the templates comprising a graph, a grid, and a hierarchical grid.

23. The computer readable medium of claim 20 further comprising instructions to:
group the test artifacts into projects; and
organize the projects as a hierarchy.

24. The computer readable medium of claim 23 further comprising instructions to generate the report from any level in the hierarchy.

25. The computer readable medium of claim 20 further causing the processor to report a third test data element, the processor being caused to:
store a second mapping strategy in memory for mapping an application-specific terminology of third test data element to a standard terminology;
assign the third test data element to a third test artifact using the second mapping strategy;
translate application-specific terminology of the third test data element to the standard terminology using the second mapping strategy; and
deliver a report showing first, second, and third test data elements expressed in the standard terminology and displayed in a single view.

26. A system for normalizing test data produced by multiple test management tools, the system comprising:
a first collection of one or more data files containing data elements produced by a plurality of different test management tools; and
a mapping module configured to receive the first collection of data files and convert terminology of the data elements stored in the first collection of data files to a standard terminology.

27. The system of claim 26 further comprising:
a second collection of one or more data files containing the converted data elements.

28. The system of claim 27 further comprising:
a display adapted to present a report of the converted data elements.

29. The system of claim 28 wherein the report is delivered to a user electronically.

30. The system of claim 29 wherein the report is delivered to a user via a password-secured web interface.

31. The system of claim 26 wherein the mapping module is further configured to map the data elements to a plurality of hierarchical groupings.

32. The system of claim 31 wherein the mapping module stores instructions for converting the data elements into the standard terminology and for mapping the data elements to the plurality of hierarchical groupings.

33. The system of claim 26 further comprising tools for extracting the first collection of one or more data files from the test management tools.

34. The system of claim 33 wherein the tools automatically extract the first collection of one or more data files.
